(19) United States
(12) Patent Application Publication
(10) Pub. No.: US 2010/0215826 A1
(43) Pub. Date: Aug. 26, 2010

(54) Snack Cracker and Method for Making Same

(75) Inventors: Gordon Douglas Campbell, Beckingham (GB); David Paul Jones, Bushby (GB); Joanna Louise Peart, Beckingham (GB); Andrew Paul Thomas, Loughborough (GB)

Correspondence Address: CARSTENS & CAHOON, LLP, P O BOX 802334, DALLAS, TX, 75380, US

(73) Assignee: FRITO-LAY TRADING COMPANY GMBH, Bern (CH)

(21) Appl. No.: 12/393,465

(22) Filed: Feb. 26, 2009

(51) Int. Cl. A21D 10/00; A23B 4/03

(52) U.S. Cl. 426/549; 426/465

(57) ABSTRACT

The present invention discloses formulations for sheeted, baked fruit and vegetable crackers that have a light, crispy texture similar to a potato chip or cracker. Undehydrated ingredients are combined with dry ingredients and oil to make a dough, which is then sheeted and cut into pieces. The pieces are baked to produce vegetable and fruit snack crackers.

### BACKGROUND OF THE INVENTION

1. Technical Field

The present invention relates to a method for making an improved baked snack food and more particularly to a method for making a baked, sheeted snack food made from an undehydrated ingredient such as a puree thereby having a relatively high nutritional level and having a shape and texture similar to a conventional prior art snack food.

2. Description of Related Art

Baked snack foods such as potato chips are popular consumer items for which there exists a great demand. Potato chips have a light, crispy texture and can be prepared by cooking slices of whole potatoes. They can also be created by using potato (lakes and water to create a starchy dough. The dough is sheeted, cut into pieces of a desired shape, and cooked. The dough is compressed between a pair of counter rotating sheeter/cutter rollers that are located closely together, thereby providing a pinch point through which the dough is formed into sheets and cut into a desired shape. Often the desired snack piece shape is that of a square or circle. After the dough is cut into pieces, the pieces are transported towards and through an oven, which reduces their moisture content. The snack pieces are then sent to be packaged.

Although potatoes fall into the broad category of vegetables, the nutritional benefits offered by potatoes are different from the nutritional benefits offered by other more colorful, less starchy vegetables. Because potato starch is the main source of nutrition in conventional potato chips, a snack chip that prominently features other vegetables as additional sources of nutrition is an improvement over potato chips.

One prior art attempt of making a plant based snack food is exemplified by U.S. Pat. No. 5,264,238 (hereinafter “Taga et al”). The Taga et al reference discloses mashing a plant-based ingredient and forming the mash into a paste having a moisture content of 50% to 85% by weight after the addition of a saccharide and dried to achieve a bulk density ranging from 0.3 to 0.8 g/ml. Such high bulk densities fail to provide the light crispy texture that consumers have come to expect from snack foods. Further sheets of food having moisture contents above 50% by weight are difficult to sheet and cut into smaller pre-forms. This difficulty is exemplified by every example of the Taga et al reference which teaches squeezing the paste-like substance into sticks.

Some prior art vegetable snack foods take the form of dehydrated slices of whole vegetables. These prior art dehydrated slices are not sheeted snack chips and do not have the light, crispy cracker-like texture desired by consumers. Many sheeted vegetable chips or crackers in the prior art have included trivial or insubstantial amounts of vegetables, thus they are not nutritionally different from traditional potato chips. Such food products are typically made with dehydrated Hours or powders. Some consumers and government agencies do not consider foods made principally from dehydrated vegetable material to be made from “real” food ingredients. Such flour-based baked foods also require chemical additives such as hardstock and/or physical processing such as the addition of docking holes to prevent blistering in the oven. Further, such products typically require relatively high levels of seasoning to produce a palatable food product. High levels of seasoning can result in high levels of sodium. No prior art snack food has been able to deliver high levels of vegetables, along with the additional hallmarks of nutritious snacks listed above, in the form of a light, crispy snack chip produced from sheeted dough. Consequently, the need exists for a healthy, nutritious snack chip having a high content of fruits or vegetables and a light, cracker-like crispy texture.

### SUMMARY OF THE INVENTION

The present invention provides a great tasting, healthy snack chip having a high content of fruit or vegetable, and a form and texture similar to a potato chip or cracker. In one aspect of the invention, a pureed fruit is used as a healthy ingredient in sheeted, baked snack chips. In another aspect of the invention, a pureed vegetable is used as a healthy ingredient in sheeted, baked snack chips. In one aspect of the invention, a pureed fruit and vegetable blend is used as a healthy ingredient in sheeted, baked snack chips. In one aspect, the sheeted, baked snack chips are made without the use of hardstock thereby providing a baked sheeted snack chip having a reduced level of saturated fat as compared to prior snacks. In one aspect of the invention, a sheeted dough is made with minimal or no added water. In one aspect of the invention, a sheeted baked snack chip is seasoned with a reduced level of topical seasoning thereby providing a baked sheeted snack chip having a reduced level of sodium as compared to prior art snack chips. In one aspect of the invention, blistering in the sheeted baked snack chips is reduced by the addition of natural blister reducing agents and no docking is required. These as well as additional features and advantages of the present invention will become apparent in the following written description.

### DETAILED DESCRIPTION

The baked snack chips of the present invention are high in nutritional content because of the high content of undehydrated ingredients used to make the snack chips. As used herein, an undehydrated ingredient is defined as a food ingredient other than water that is sourced from an undehydrated state. In one embodiment the undehydrated ingredient is selected from a raw natural ingredient, a fruit or vegetable juice, soup, and mixtures thereof. Dry ingredients such as dried vegetable, cereal, and fruit flakes including, but not limited to, potato flakes, all flours, starches, fruit powders, and vegetable powders are explicitly excluded from the definition herein of an undehydrated ingredient.

As used herein a raw natural ingredient is a fruit or vegetable ingredient that has a moisture content that is within about 5% and more preferably within about 3% and most preferably within about 1% of its native moisture content. Examples of raw natural ingredients include raw fruits and vegetables, individually quick frozen (“IQF) fruits and vegetables, pureed fruits and vegetables, concentrated fruits and vegetables, and fruits and vegetables that have been steamed, blanched, boiled, and/or roasted. As used herein, a pureed fruit or vegetable is a natural food product that has been ground, pressed, or strained to the consistency of a soft paste of thick liquid.

As used herein, the term fruit is used in the culinary sense and includes those botanical fruits that are sweet and fleshy. Examples of fruit include, without limitation, apple, strawberry, blueberry, cranberry, plum, peach, mango, banana, pear, grape and orange.

The term vegetable is used herein in the culinary sense and includes those plant fruits that are savory, as opposed to sweet. Examples of vegetables include, without limitation, carrot, parsnip, swede, cabbage, spinach, peas including chickpeas, kale, turnip, celery, pumpkin, tomato, onion, bell pepper, red pepper, yellow pepper, beet, cucumber, broccoli, cauliflower, squash, zucchini (courgette), artichoke, asparagus, lentil, mushroom, beans (French beans, navy beans, pinto beans), herbs, spices, and seeds. In one embodiment, root vegetables such as radishes, carrots, parsley root, celeriac, beetroot, turnips and swedes are used as such vegetables provide desired flavors in the finished baked sheeted snack chip. In one embodiment, alium (bulb) vegetables such as onions, leeks, garlic, chives, and shallots are used as vegetables as such vegetables also provide desired flavors in the finished baked sheeted snack chip.

As used herein, juice is defined a liquid nutritional product containing one or more vegetable and/or fruit juices, extracts, or concentrates thereof. Specific examples include juices which are primarily comprised of at least one fruit or vegetable juice or juice concentrate. The term “juice” as used herein also encompasses liquid nutritional products which contain juices or concentrates thereof. A specific example of a juice in accordance with this invention includes a juice or juice concentrate which is combined with yoghurt, and also includes beverages referred to as smoothies.

As used herein, soup is defined as a food prepared from meat, poultry, fish, vegetables, grains, fruit and other ingredients, cooked and/or retorted in a liquid which may include visible pieces of some or all of these ingredients. It may be clear (as a broth or vegetable stock) or thick (as a chowder), smooth (crushed tomato paste), pureed or chunky (salsa), ready-to-serve, semi-condensed or condensed.

In one embodiment, one or more undehydrated ingredients defined above are mixed with dry ingredients, and optionally minor ingredients including, but not limited to oil, herbs, spices, seeds and added water to form a dough. In one embodiment, a dry ingredient is an ingredient that has been dried to a moisture content of less than about 15% by weight. The dry ingredients help maintain dough cohesiveness and expansion during cooking, and contribute to the final product light, crispy texture and enhanced flavor. Examples of dry ingredients include flours, starches, powders, flakes, and granules. Flours that can be used in accordance with the present invention include, but are not limited to flour made from oat, wheat, corn, rye, barley, rice, potato, and mixtures thereof. Starches that can be used in accordance with the present invention include, but are not limited to, starches made from wheat, corn, tapioca, sago, rice, potato, oat, barley, ameranth; modified starches including but not limited to hydrolyzed starches such as maltodextrins, high amylose corn maize, waxy corn starch, high amylopectin corn maize; chemically substituted starches, cross linked starches; native starches, and dehydrated starches, starches derived from tubers, legumes and grains, for example corn starch, wheat starch, rice starch, waxy corn starch, oat starch, cassava starch, waxy barley, waxy rice starch, glutinous rice starch, sweet rice starch, potato starch, tapioca starch, and mixtures thereof. Dry ingredients also include potato flakes, granules, and agglomerates.

In one embodiment, potato flakes are included as a dry ingredient to help the dough expand as it cooks, and give the final product its light, crispy texture. Potato flakes are made from potatoes that have been cooked, mashed, and dried.

In one embodiment, starch is included as an ingredient in the dough to aid cohesiveness, expansion, texture, and breakage reduction. Starches, including, but not limited to modified starch, pre-gelatinized starch, and native starch can be used.

In another embodiment, whole oat flour is included as an ingredient to improve the flavor of the final product and to enhance the nutritional value of the snack by adding whole grain fiber, vitamins and minerals. Oat Hour can also contribute to a cracker like final product texture.

Examples of natural whole or ground herbs and spices include, but are not limited to garlic, tarragon, dill, marjoram, sage, basil, thyme, oregano, cumin, cilantro, chili powder, coriander, mustard, mustard seed, rosemary, paprika, curry, cardamon, fennel seeds, bay, laurel, cloves, fennugrek, parsley, turmeric, chives, scallions, leeks, shallots, cayenne pepper, bell pepper, hot peppers, and combinations thereof. Each of the different fruits and non-starchy vegetables used in the present invention are rich in different nutrients and have nutritional benefits different from potatoes and other starchy vegetables.

In one embodiment up to about 3% oil by weight is optionally added. Oils added can include, but are not limited to high oleic sunflower oil (HOSO), olive oil, extra virgin olive oil, rapseed oil, and mixtures thereof. In one embodiment, the dough comprises up to 5% and more preferably less than about 2% and most preferably no added water. As used herein, added water is defined as process water which has been added to the undehydrated ingredient/dry ingredient mixture. Added water does not include moisture inherent in the undehydrated ingredients, dry ingredients, herbs, spices, seeds or oil.

In one embodiment, the dough comprises dry ingredients of between about 35% and about 60% and more preferably between about 37% and about 50% and most preferably between about 43% and about 46% by weight of the dough. These weight percentages are on a wet dough basis, e.g., after the addition of one or more undehydrated ingredient(s).

In one embodiment, the dough comprises one or more undehydrated ingredients of between about 35% and about 65% and more preferably between about 39% and less than 50% by weight of the dough. These weight percentages are on a wet dough basis. In one embodiment sufficient undehydrated ingredients are added so that less than about 5% by weight added water, more preferably less than about 3% and most preferably less than about 1% by weight added water is used to make a sheetable dough. In one embodiment, the sheetable dough comprises a moisture content of less than 50% by weight. The present invention thereby provides a way to make a dough with minimal or no added water.

In one embodiment, the dry ingredients are mixed together for between about 1 and about 3 minutes prior to adding the dry ingredients to one or more undehydrated ingredient. In one embodiment, the dough ingredients comprising the dry ingredients and one or more undehydrated ingredients is mixed for between about 1 and about 3 minutes or other suitable time to make the sheetable dough.

In one embodiment of the present invention, dough comprising raw natural ingredients, dry ingredients, oil and optionally herbs, spices, and/or seeds is sheeted to a final sheet thickness of between about 0.5 mm to about 1.0 mm or other suitable thickness, and cut into pieces of a desirable shape. In the sheeting step, the dough is compressed between at least one pair of counter rotating sheeter/cutter rollers that are located closely together, thereby providing a pinch point through which the dough is formed into sheets. In one embodiment, the pinch point or roller gap through which the dough is sheeted is between about 0.2 mm and about 1.0 mm. In one embodiment water is added to the dough prior to the sheeting step to aid in process control. For example, if the desired moisture content of the dough at the sheeter is 45% by weight, sufficient undehydrated ingredients and dry ingredients can be mixed together to obtain a dough having 44.5% moisture and additional water can be added just prior to the sheeter to achieve a dough moisture content of 45% by weight.

The cut dough pieces are can then baked in a primary oven at an oven temperature between about 177° C. (350° F.) and about 282° C. (540° F.) until the pieces have a moisture content of about 18% to about 33%. In one embodiment, the pieces are baked in a primary oven having an oven temperature of about 250° C. for about 65 seconds. The pieces can then baked in a secondary oven at an oven temperature between about 113° C. (235° F.) and about 137° C. (280° F.) to form crackers having a final moisture content between less than about 2% of the total product weight. In one embodiment, the pieces are baked in the secondary oven having an oven temperature of about 120° C. for about 20 minutes.

In one embodiment, the baked snack cracker of the present invention will have a bulk density of between about 0.06 g/mL and about 0.12 g/mL, Such bulk can provide the desired light, crispy texture.

Examples of various embodiments are provided below.

### Example 1

The table below illustrates the ingredients and their relative amounts that were used to make a vegetable cracker dough according to the present invention:

TABLE 1
Vegetable Cracker Dough.

| | | Wt. % |
|---|---|---|
| Ingredient | Quantity (g) | Dough |
| Potato Flakes | 70.0 | 27.39 |
| Waxy Corn Starch | 25.0 | 9.78 |
| Soy Lecithin | 2.6 | 1.02 |
| Mono calcium | 1.0 | 0.39 |
| phosphate | | |
| Sodium bicarbonate | 0.8 | 0.31 |
| Oat Flour | 20.0 | 7.83 |
| Sugar | 5.0 | 1.96 |
| Dry Ingredient Total | 124.4 | 48.68 |
| Sunflower Oil | 3 | 1.17 |
| Added Water | 0 | 0 |
| Total Liquids Added | 3 | 1.17 |
| Cooked Carrot | 37.5 | 14.67 |
| Garlic Paste | 1.5 | 0.59 |
| Cooked Parsnip | 37.5 | 14.67 |
| Cooked Onions | 11.25 | 4.4 |
| Cooked Swede | 37.5 | 14.67 |
| Raw Natural | 125.25 | 49.00 |
| Ingredient Total | | |
| Fresh Lemon Thyme | 1.40 | 0.55 |
| Fresh Rosemary | 1.40 | 0.55 |
| Black Pepper | 0.13 | 0.05 |
| Herbs/Spices Total | 2.93 | 1.15 |

In this embodiment, the undehydrated ingredients were first prepared. The carrots, parsnips, and swede were chopped evenly into 15 mm pieces and steamed for 15-20 minutes until cooked. The onion was peeled and chopped finely (minced) in a food processor. The lemon thyme and rosemary were rinsed and blotted dry. The leaves were removed from the stem and the leaves were finely chopped by hand. Two grams of sunflower oil, the minced onion and the garlic paste were mixed together in a frying pan. The onion, lemon, thyme, rosemary, and oil ingredients stirred and cooked for 2-3 minutes until the onions softened. The carrots, parsnip and swede were then added to the frying pan and stir fried for one minute. The black pepper was then stirred in. The cooked vegetable/herb admix was removed from heat and placed into a lidded container.

The dry ingredients were admixed in a bowl with a handmixer. Next the cooked vegetable/herb admix and one gram of sunflower oil were added to the dry admix. The mixture was slowly blended together by hand with the use of a dough hook for about 20 seconds. The ingredients were then placed onto a clean board and kneaded for about 2 minutes. The dough was then manually rolled into a sheet using a pastry roller into a sheet about 5 mm thick. The sheet of dough was cut into smaller pieces and passed through pasta rollers to make a final sheet thickness of between about 0.5 mm and about 1.0 mm. A cookie cutter was then used to cut the sheet into a plurality of pieces. The cut pieces were placed onto a board and covered with plastic to reduce surface drying. The pieces were then placed onto a screen mesh and put into an impingement oven where the pieces were agitated for 90 seconds al 205° C. The product was then finished dried in a forced air lab oven for 10 minutes at 120° C. to a moisture content of less than 1.5% by weight.

The table below illustrates the relative amount of each ingredient's dry matter and the moisture content in the fully cooked, unseasoned vegetable chips produced using the dough ingredients and relative amounts listed in Table 1 above.

TABLE 2
Weight Percentages of Ingredient Components in Finished Product

| Constituent | Wt. % Final Product |
|---|---|
| Potato Flakes | 46.07 |
| Waxy Corn Starch | 16.72 |
| Soy Lecithin | 1.82 |
| Mono calcium phosphate | 0.67 |
| Sodium bicarbonate | 0.54 |
| Oat Flour | 13.45 |
| Sugar | 3.54 |
| Total from Dry Ingredients | 82.81 |
| Sunflower Oil | 2.13 |
| Carrot | 2.79 |
| Garlic | 0.37 |
| Parsnip | 4.65 |
| Onion | 2.79 |
| Swede | 2.33 |
| Raw Natural Ingredient Total | 12.93 |
| Lemon Thyme | 0.34 |
| Rosemary | 0.32 |
| Black Pepper | 0.09 |
| Herbs/Spices Total | 0.75 |
| Moisture | 1.38 |

The vegetable chips described in the above example contained 13.68% vegetable solids from raw natural vegetables including 12.93% from carrots, garlic, parsnip, onion, and swede and 0.75% from lemon thyme, rosemary, and black pepper. Based on a 28-gram serving there are 3.83 grams of vegetable solids (28 g*0.1368) sourced from raw vegetables. They also had a light, crispy texture similar to that of a cracker. In addition, the vegetable chips disclosed herein met or exceeded desired nutritional goals. Specifically, the chips disclosed above had, per 28 gram serving, less than 5 g of fat, 1.5 gram or less of saturated fat, zero trans-fatty acids, 2.6 grams of dietary fiber, less than 25% calories from added sugar, and no more than 500 milligrams of sodium. In sum, the result is a healthy, nutritious snack chip high in vegetable content and having a light, crispy texture similar to a prior art Hour-based cracker.

### Examples 2-4

Table 3 provides an example of dry ingredients that can be admixed with oil and added to any undehydrated ingredient in Table 4 to make a dough that can be used to make a veggie cracker in accordance with one embodiment of the present invention. For example, in one embodiment, 150 grams of the dry mix depicted in Table 3 can be admixed together in a mixer at ambient temperature for about 2 minutes.

TABLE 3
Dry Ingredient Mixture.

| | | g per 150 g |
|---|---|---|
| Dry Ingredient | % Dry Mix | Dry Mix |
| Potato Flakes | 35.5 | 53.25 |
| Rice Flour | 35.5 | 53.25 |
| Waxy Corn Starch | 14.6 | 21.9 |
| (XpandR) | | |
| Oat Flour | 12.4 | 18.6 |
| Soy Lechithin | 1.1 | 1.65 |
| Palm Fat | 0.8 | 1.2 |
| Ground Black Pepper | 0.1 | 0.075 |
| Total | 100 | 150 |

TABLE 4
Selected Undehydrated Ingredients and Inherent Moisture Contents.

| | | Moisture |
|---|---|---|
| | Wet | Content % |
| Undehydrated Ingredient | Weight | (McCance) |
| Brocolli | 105 | 91.1 |
| Spinach | 105 | 91.6 |
| Pea | 120 | 78.3 |
| Sweet Potato | 105 | 74.7 |
| Red and Yellow Pepper | 105 | 89-92 |
| Tomato | 105 | 93.1 |
| Carrot | 105 | 90.5 |
| Root veg medley (Blend of ingredients) | 101.5 | 86.0 |
| Cauliflower | 101.5 | 90.6 |
| Butternut Squash | 101.5 | 87.8 |
| Leek | 101.5 | 92.2 |
| Beetroot (vacpack) | 101.5 | 83 |
| Beetroot (sweetfire) | 101.5 | 83 |
| French beans | 101.5 | 90 |
| Broad bean | 101.5 | 73.8 |
| Mushroom | 101.5 | 92.6 |
| Courgette | 101.5 | 93 |
| Baked Bean | 150 | 71.5 |
| Lentil | 225 | 70 |
| Pinto bean grits | 210 | 66 |
| Black bean grits | 190 | 66 |
| Navy bean grits | 250 | 66 |

The dry mix in Table 3 above can then be added to any one of the ingredients and corresponding amounts listed in Table 4 along with 2.5 grams of high oleic sunflower oil (HOSO) to make a dough. In the embodiments listed in Tables 3 and 4, no added water is necessary to make a sheetable dough.

### Example 2

In one embodiment, 105 grams of raw tomatoes having 93.1% moisture by weight can be cut up and admixed with the dry mix composition in Table 3 and three grams of HOSO to make a dough. The dough can be sheeted, cut and dried as discussed above to make a vegetable cracker. In one embodiment, less than about 0.5% by weight, and more preferably less than about 0.4% by weight of topical salt can be added.

### Example 3

In one embodiment, 225 grams of raw lentils having 70% moisture by weight can be cut up and admixed with the dry mix composition in fable 3 and three grams of HOSO to make a dough. The dough can be sheeted, cut and dried as discussed above to make a vegetable cracker. In one embodiment, less than about 0.5% by weight, and more preferably less than about 0.4% by weight of topical salt can be added.

### Example 4

Undehydrated ingredients other than raw vegetables disclosed in Table 4 can also be used in accordance with various embodiments of the present invention. For example, the dry ingredients listed in Table 3 above were also admixed with each of the ingredients listed in Table 5 below to make a dough.

TABLE 5
Selected Undehydrated Ingredients and Inherent Moisture Contents

| | | Moisture |
|---|---|---|
| | | Content % |
| Juice | Wet Weight | (McCance) |
| Raspberry & Pomegranate | 110 | 87 |
| Blackcurrant & Blackberry | 110 | 87 |
| Strawberry & Banana | 115 | 87 |
| Pineapple, Mango & Passionfruit | 115 | 87 |

Thus, for example, 115 grams of a strawberry & banana flavored TROPICANA SMOOTHIES were added to 150 grams of the dry ingredient mixture listed in Table I above, along with 2.5 grams of high oleic sunflower oil (HOSO) to make a dough that can be sheeted, cut and baked to make a fruit cracker.

In any of Examples 1-3 above, the snack food can then optionally be seasoned in seasoning tumbler and then packaged. The present invention requires much less topical seasoning than prior art crackers or chips. Consequently, in one embodiment, the snack cracker of the present invention comprises less than about 1500 mg of salt per 100 g serving, more preferably less than about 1000 mg of salt per 100 g serving and most preferably less than about 300 mg of salt per 100 g serving. One reason less topical seasoning is required in the present invention is from the fact that such high levels of raw natural ingredients are used. Because the raw natural ingredients are used instead of dehydrated flour, many of the natural vegetable flavors are retained in the finished baked chip, thereby substantially decreasing the amount of added sugar necessary to make a palatable cracker. Prior art crackers and chips, on the other hand, are made from Hours where sugars are leached out and some of the more volatile aromatic flavors are permanently lost during dehydration when the flour is made, further, the raw or fresh vegetable ingredients provide an authentic flavor and pleasant mouthfeel. Moreover, the use of herbs and spices can provide more natural visual cues to the consumer than artificial, topical seasonings.

One advantage of the present invention is that because raw natural ingredients having near native moisture levels are being used, little if any added water is required to form a cohesive dough. In one embodiment, the dry ingredients such as potato flakes are hydrated by mixing with the vegetable puree made from raw natural ingredients. Consequently, the dehydration/rehydration cycle required by prior art crackers (by rehydrating dry ingredients to make a dough) is advantageously omitted for a significant portion of the dough ingredients in one embodiment of the present invention.

The use of undehydrated ingredients in place of flours also permits substantially less added sugar to be used in the dough formulation of the present invention as compared to prior art crackers. Consequently, in one embodiment, the present invention comprises a dough having less than about 12.5 g of added sugar per 100 g serving, more preferably less than about 6 g of added sugar per 100 g serving and most preferably having no added sugar.

In one embodiment, the use of herbs, spices, and/or seeds as an ingredient results in several advantageous benefits. One benefit is the reduction of the “pillowing” or “blistering” effect that can take place during baking by providing small vents in the dough that allow steam to escape while the snack chip is cooking. In prior art crackers, hard stock beads (e.g., oil or fat), glycerides, and/or docking was required to reduce pillowing or blistering. The use blister reducing agents such as herbs, spices, and/or seeds when properly sized and used as inclusions, can provide channels within the dough to permit steam to escape and reduce or eliminate pillowing. Consequently, one advantage of one embodiment of the present invention is that a sheeted, cracker-like snack food product can be made without the use of hardstock, glycerides, and/or docking. Another benefit of herbs, spices, and/or seeds is the flavor provided by a natural ingredient source. Moreover, such ingredients can advantageously substitute for prior art seasonings because herbs, spices and seeds do not stick to a consumers fingers like many topical seasonings. Further, herbs, spices, and/or seeds can provide natural visual cues to the consumer and can also reduce the overall sodium level required to obtain a palatable finished food product.

Having thus described several aspects of at least one embodiment of this invention, it is to be appreciated that various alterations, modifications, and improvements will readily occur to those skilled in the art. For example, one or more undehydrated ingredients listed in Tables 4 and 5 can be used in combination. Such alterations, modifications, and improvements are intended to be part of this disclosure, and are intended to be within the spirit and scope of the invention. Accordingly, the foregoing description are by way of example only.

What is claimed is:

1. A sheetable cracker dough, wherein said dough comprises by weight:
at least about 35% dry ingredients:
one or more undehydrated ingredients;
less than about 3% oil;
less than about 5% added water; and
a moisture content of less than 50% by weight.

2. The dough of claim 1 further comprising no hardstock.

3. The dough of claim 1 wherein said undehydrated ingredients comprise less than about 65% by weight of said dough.

4. The dough of claim 1 wherein said undehydrated ingredient comprises a raw natural ingredient.

5. The dough of claim 1 wherein said undehydrated ingredient comprises juice.

6. The dough of claim 1 wherein said undehydrated ingredient comprises vegetable stock.

7. The dough of claim 1 wherein said undehydrated ingredient comprises soup.

8. The dough of claim 1 further comprising no added water.

9. A sheetable cracker dough, wherein said dough comprises by weight:
at least about 35% undehydrated ingredients;
one or more dry ingredients;
less than about 3% oil;
less than about 5% added water; and
a moisture content of less than 50% by weight.

10. The dough of claim 9 further comprising no hardstock.

11. The dough of claim 9 wherein said dry ingredients comprise at least about 35% by weight of said dough.

12. The dough of claim 9 wherein said undehydrated ingredient comprises at least one raw natural ingredient.

13. The dough of claim 9 wherein said undehydrated ingredient comprises juice.

14. The dough of claim 9 wherein said undehydrated ingredient comprises vegetable stock.

15. The dough of claim 9 wherein said undehydrated ingredient comprises soup.

16. The dough of claim 9 further comprising no added water.

17. A method for making a cracker, said method comprising the steps of:
a) admixing dry ingredients, and pan fried ingredients to form a dough, wherein said dough comprises at least about 35% by weight undehydrated ingredients; and
b) sheeting and cutting said dough into a plurality of pieces; and
c) dehydrating said pieces to a moisture content of less than about 2% by weight to make a plurality of crackers, wherein said crackers comprise a bulk density of between about 0.06 and about 0.12 g/mL.

18. The method of claim 17 wherein less than about 5% added water is admixed into said dough prior to step c).

19. The method of claim 17 wherein no added water is added in steps a) through c).

20. The method of claim 17 further comprising the step of adding between about 0.1% and about 0.5% by weight salt.

21. The method of claim 17 wherein said dehydrating at step d) comprises dehydrating in a primary dryer having an oven temperature of between about 177° C. (350° F.) and about 282° C. (540° F.) to a moisture content of between about 18% and about 33% by weight.

22. The method of claim 17 wherein said dehydrating at step d) comprises dehydrating in a secondary dryer having an oven temperature of between about 113° C. (235° F.) and about 137° C. (280° F.).

23. The method of claim 17, wherein said dough is not docked prior to step c).

24. The method of claim 17, wherein blister reducing agents are admixed at step a).
